(19) United States
(12) Patent Application Publication
(10) Pub. No.: US 2008/0288689 A1
(43) Pub. Date: Nov. 20, 2008

(54) Opportunistic granting arbitration scheme for fixed priority grant counter based arbiter

(76) Inventors: Brian Hoang, Puyallup, WA (US); Khee Wooi Lee, Penang (MY)

Correspondence Address: TROP PRUNER & HU, PC, 1616 S. VOSS ROAD, SUITE 750, HOUSTON, TX, 77057-2631, US

(21) Appl. No.: 11/803,287

(22) Filed: May 14, 2007

(51) Int. Cl. G06F 13/36

(52) U.S. Cl. 710/113

(57) ABSTRACT

In one embodiment, an arbiter may provide for opportunistic granting of one or more grants to a requestor that has no available fixed grants remaining in a given arbitration round. In one embodiment, a method may detect that a target resource to be accessed by a requestor with a valid grant count is unavailable during an arbitration round, and opportunistically grant an access grant to another requestor to access a different target resource for a slot of the round. Other embodiments are described and claimed.

### BACKGROUND

To prevent deadlocks and stalls in a system, an arbiter may be present to receive requests from multiple agents and arbitrate the requests to provide access grants to resources of the system. In some systems, arbitration is performed according to a fixed priority privilege in which a certain number of grants are allowed to avoid a higher priority requestor from starving lower priority requestors. Grant operation typically starts from the highest priority requester and proceeds to the lowest priority requestor. In some systems, the lower priority requestor can only receive a grant when higher priority requestors have no active requests or have exhausted their grant count. Requestors commonly receive reloaded grant counts when no active requests are present, every requestor participating in arbitration has exhausted their grant counts, or no active request from any requester with a grant count exists.

A common starvation problem with this arbitration scheme is when one of the requestors has not exhausted its grant count but could not be granted a grant due to a lack of required target resources. When this scenario occurs, no requestor with active requests can receive a grant once they have reached their grant count limit, causing grant operation to come to a stall until the target resource is freed up. While this problem can be resolved by reloading grant counts, this solution can cause starvation in lower priority requestors and thus arbitration fairness no longer prevails.

### BRIEF DESCRIPTION OF THE DRAWINGS

FIG. 1 is a timing diagram of performing opportunistic granting in accordance with an embodiment of the present invention.

FIG. 2 is a block diagram of a system in accordance with an embodiment of the present invention.

FIG. 3 is a block diagram of an arbiter in accordance with one embodiment of the present invention.

FIG. 4 is a block diagram of a system in accordance with one embodiment of the present invention.

### DETAILED DESCRIPTION

In various embodiments, an arbiter may provide for opportunistic granting of requests from one or more requesters. More specifically, in an arbiter that provides for a fixed priority for N number of requestors, when a required resource is unavailable for a given requestor during an arbitration cycle, the arbiter may opportunistically grant one or more requests to other requestors that seek to access available resources in place of the fixed priority requestor. In this way, stalls due to unavailable resources for a fixed requestor can be avoided.

Accordingly, to service requests from requesters with no grant count remaining, a secondary arbitration unit may run along aside a primary arbitration unit to arbitrate requests with sufficient required resources and an insufficient grant count, and opportunistically inject grant-by-grant when the primary arbitration unit cannot grant to any requesters with sufficient grant count and insufficient required resources. As shown in the truth table of Table 1, embodiments allow granting to a requestor with no grant count but with required resources available. With this arbitration policy, it is guaranteed that no arbitration stall could occur due to lack of a grant count, while at the same time prevailing to a fixed priority arbitration.

TABLE 1

| Gcnt | Rsc | Grant |
|---|---|---|
| 0 | 0 | 0 |
| 0 | 1 | 1 (Opportunistic Arb) |
| 1 | 0 | 0 |
| 1 | 1 | 1 (Fixed Priority Arb) |

Thus as shown in Table 1 a resource having a grant count of zero may be granted an opportunistic arbitration slot when a required resource is available (i.e., having an available indicator 1), reducing stalls by enabling the requestor to gain access to the required resource when it is available.

Opportunistically granting access to a resource enables a system's performance to come close to the ideal case where no resource conflict occurs. Likewise, the longer the delay penalty the higher the performance ratio over a fixed priority arbiter. For this particular example of starvation due to the resources lacking scenario, embodiments may realize an appreciable gain in performance over a fixed priority arbiter. In reality, the resource conflict penalty is significantly higher, and thus the performance gain will be proportionally higher.

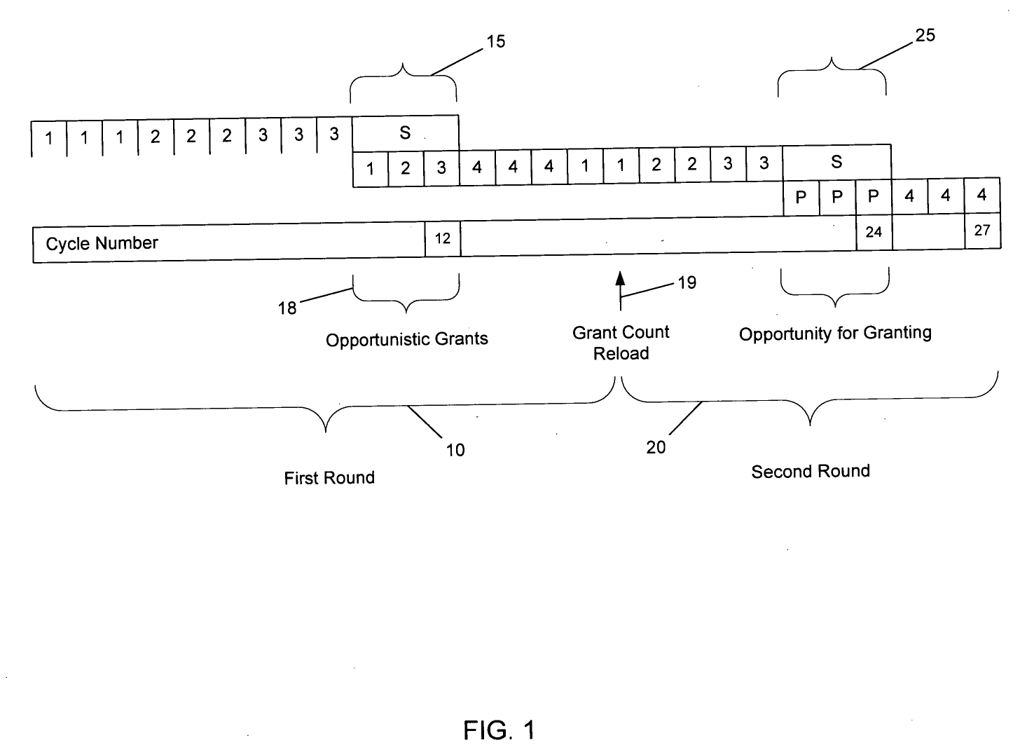

Referring now to FIG. 1, shown is a timing diagram of performing opportunistic granting in accordance with an embodiment of the present invention. As shown in FIG. 1, two arbitration rounds 10 and 20, respectively, are shown each corresponding to a varying number of cycle counts, each round having a number of slots. As shown in FIG. 1, each of four requesters 1-4 is provided access to given resources for some number of cycles of the corresponding arbitration round. Specifically as shown in FIG. 1, in first round 10 requestors 1-3 are cyclically provided with three cycles each. These requestors 1-3 may correspond to higher priority masters. When requestor 4 obtains access according to a fixed priority arbitration scheme, a stall 15 is present due to a lack of the resource required for requestor 4. Accordingly, an opportunistic grant window 18 occurs in which three requests, one for each of the first three priority masters may be provided. Then as the required resource for requestor 4 becomes available, three grants may be provided for requestor 4. Then a grant count reload occurs as indicated with reference numeral 19. Accordingly, a second arbitration round 20 begins. During this arbitration round again a stall 25 occurs due to lack of a resource for requestor 4. Accordingly, three cycle slots P may be available for requestors having no grant count for the given second arbitration round 20. However, because resources for these requesters may be available, such opportunistic requests may be granted. Of course while shown with this particular implementation in the embodiment of FIG. 1, the scope of the present invention is not limited in this regard.

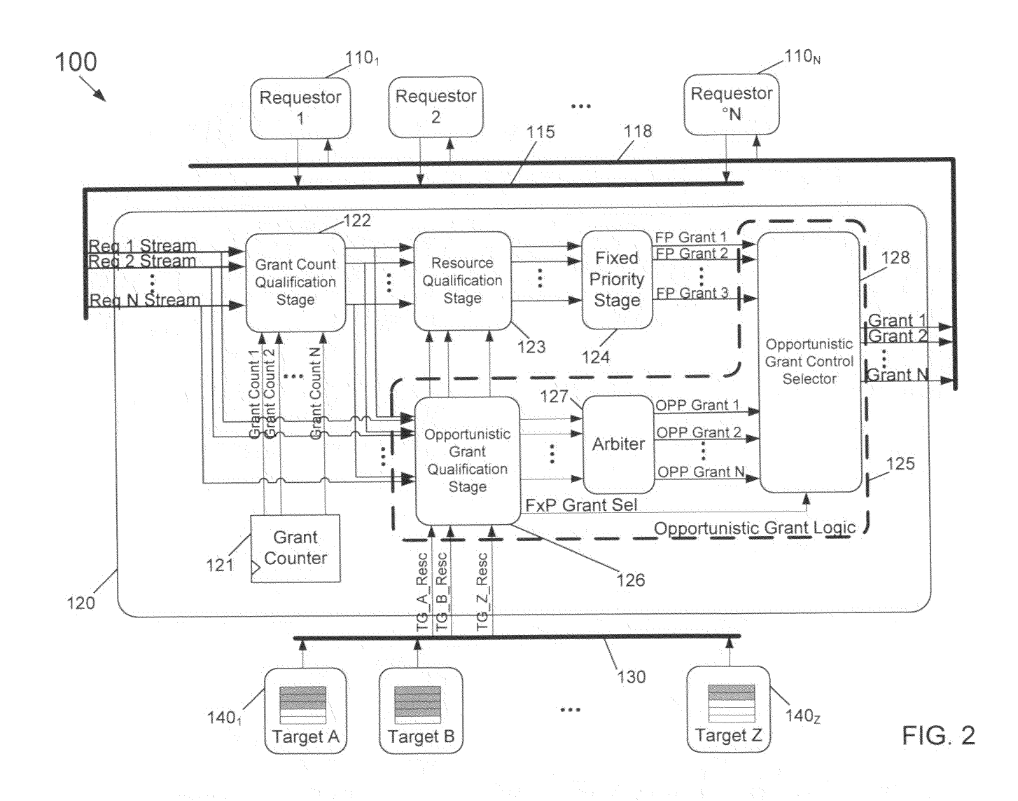

Referring now to FIG. 2, shown is a block diagram of a system in accordance with an embodiment of the present invention. As shown in FIG. 2, system 100 includes a plurality of requesters 110₁-110ₙ (generically requestor 110). Each requestor 110 is coupled to an arbiter 120 by way of a first interconnect 115 and a second interconnect 118 to provide requests to arbiter 120 and receive grants therefrom. In turn, arbiter 120 is connected via an interconnect 130 to a plurality of target resources 140₁-140_{z} (generically target resource 140).

In various embodiments, arbiter 120 may be a fixed priority grant count arbiter to provide one or more grants to each of requestors 110 during an arbitration round or cycle. However, as described above due to unavailability of a required resource for a given requester, arbiter 120 may further provide for opportunistic granting of access to available resources to one or more requestors having a zero fixed priority count.

As shown in FIG. 2, arbiter 120 may include a fixed priority portion that includes a grant count qualification stage 122, a resource qualification stage 123, and a fixed priority stage 124. Note that a grant counter 121 is coupled to grant count qualification stage 122 to provide grant counts for each of the given requesters 110. In operation, incoming request streams to grant count qualification stage 122 are processed and provided to resource qualification stage 123 that in turn is coupled to fixed priority stage 124 which thus grants fixed priority grants.

Referring still to FIG. 2, arbiter 120 further includes an opportunistic grant logic 125 that is used to provide opportunistic granting of requests when available. Specifically, opportunistic grant logic 125 includes an opportunistic grant qualification stage 126 having an output coupled to an arbiter 127, which may be a round robin arbiter, in some embodiments. In turn, opportunistic grant signals from arbiter 127 are provided to an opportunistic grant control selector 128 that combines these opportunistic grant signals along with the fixed priority grant signals from fixed priority stage 124 to thus provide grant signals to requesters 110 via second interconnect 118. Note that the status of the availability of the target resources 140 may be provided to arbiter 120 via interconnect 130. While shown with this particular implementation in the embodiment of FIG. 2, the scope of the present invention is not limited in this regard.

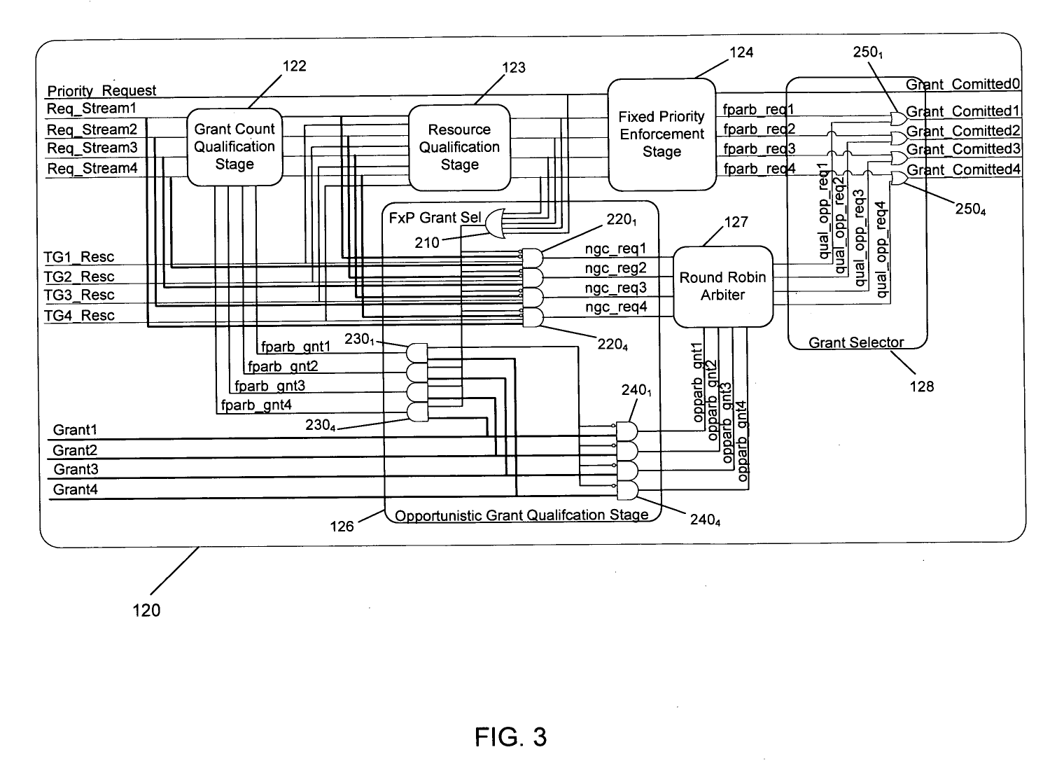

Referring now to FIG. 3, shown is a block diagram showing more details of opportunistic grant qualification stage 126 and opportunistic grant control selector 128 in accordance with one embodiment of the present invention. As shown in FIG. 3, opportunistic grant qualification stage 126 includes various logic gates to receive signals from different portions of the fixed arbitration portion as well as target resource availability information and grant information. Specifically as shown in FIG. 3, opportunistic grant qualification stage 126 includes an OR gate 210 that receives outputs from resource qualification stage 123 and provides these signals to a first set of AND gates 220₁-220₄ (generically AND gates 220), a second set of AND gates 230₁-230₄ (generically AND gates 230) and a third set of AND gates 240₁-240₄ (generically AND gates 240). The first set of AND gates 220 also receives outputs of grant count qualification stage 122, while second and third sets of AND gates 230 and 240 receive grant signals (e.g., from the output of arbiter 120). In turn, round robin arbiter 127 receives information regarding opportunistic grant information as well as resource availability information and uses the same to generate qualified opportunistic request signals that are provided to a plurality of OR gates 250₁-250₄ (generically OR gate 250) of grant selector 128 that also receive as inputs fixed priority arbitration requests from fixed priority enforcement stage 124. Accordingly, grant selector 128 provides grant committed signals to requestors 110. While shown with this particular implementation in the embodiment of FIG. 3, the scope of the present invention is not limited in this regard.

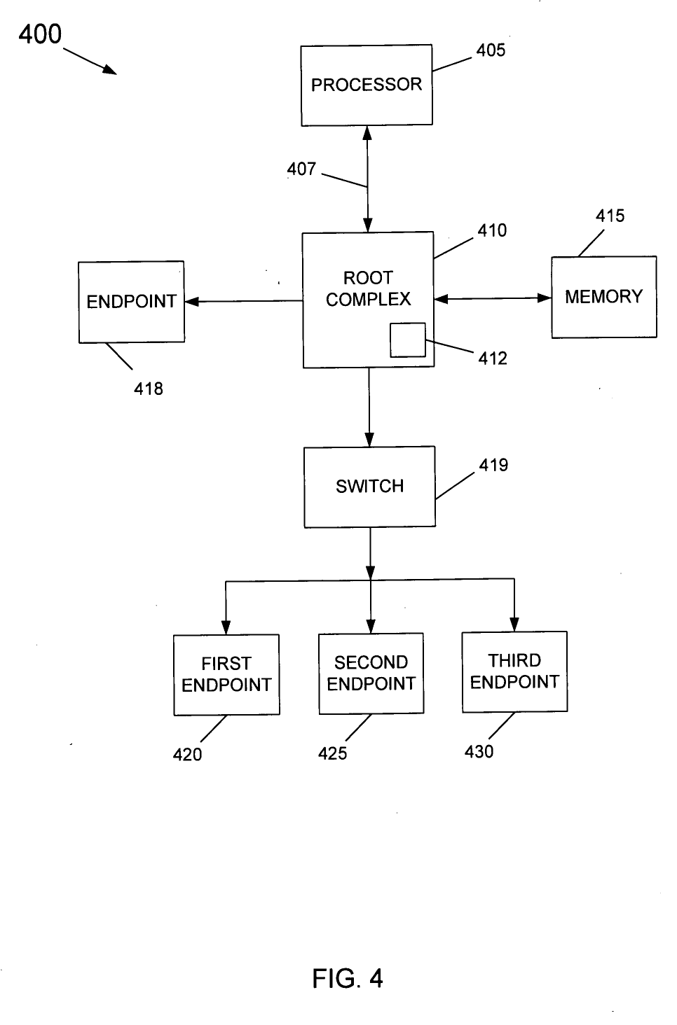

FIG. 4 shows an exemplary configuration of a system in accordance with one embodiment of the present invention, which may be a system in accordance with a Peripheral Component Interconnect (PCI) Express™ (PCIe™) architecture based on the PCI Express™ Specification Base Specification version 1.1 (published Mar. 28, 2005), or other such protocol. For example, other systems may use a PCI architecture, a common system interface (CSI) architecture, or any other point-to-point or multi-drop architecture. At the heart of the PCIe™ architecture is a root complex 410. Root complex 410 denotes the root of an input/output (I/O) hierarchy that connects the processor memory subsystem to the system's I/O devices. Accordingly, root complex 410 provides a host bridge to facilitate communications with a host processor 405 via an interface 407. Depending on the implementation, interface 407 may be a parallel bus, a set of buses, a PCIe™ link, or a combination of the foregoing. Root complex 410 is also coupled to memory 415 via an interface. Root complex 410 may support one or more PCIe™ ports to interface between the root complex and a switch or endpoint and may also be coupled to an endpoint 418, such as a display. Root complex 410 may include an arbiter 412 in accordance with one embodiment of the present invention. FIG. 4 includes a switch 419 having an upstream port connected to root complex 410 via a PCIe™ link and three downstream ports connected to endpoints. Endpoints refer to types of devices that can be a requester or completer of a transaction, either on its own behalf or on behalf of another device endpoints. The exemplary endpoints depicted in FIG. 4 include endpoints 420, 425, and 430. Such endpoints can correspond to input/output (I/O) devices, communication devices, peripheral devices, or so forth.

A deadlock may occur in a fixed priority arbiter if there is an in-out dependency on a particular agent participating in the arbitration. An agent has an in-out dependency if it is both a master (i.e., it can issue request) and a target (i.e., it is a resource of the arbiter) in the arbitration system, and it thus can enter a state where it does not free up a resource on its target interface unless the request on its master interface is granted. The in-out dependency in an agent usually occurs when an agent cannot accept more read cycles as a target before its completion cycle requests as a master are accepted.

For example, in a system where agent A is both a master (MA) and a target (TA), MA is allocated to have 1 grant per complete arbitration cycle, TA at anytime could have up to 3 outstanding requests in its queue, and the shared outgoing data queue can buffer data up to 4 requests. Two other agents involved in this case include agent B master (MB) with 4 grant counts per complete arbitration cycle and agent C master (MC) with 2 grant counts per complete arbitration cycle. At anytime MB can have 1 outstanding non-posted transaction and MC can have up to 2 outstanding non-posted transactions in the system. MB has the highest fixed priority and MC is the lowest. The fixed priority arbitration system reloads grant count allocations for all masters at the end of every completed system arbitration cycle.

The deadlock occurs when agent B master, MB, sends 1 non-posted transaction followed by 1 posted transaction (e.g., write) to TA, agent C master, MC, sends 2 non-posted transaction to TA, and at the same time agent A master, MA, sends 3 posted requests to other target in the arbitration system. In chronological order, the non-posted request from MB will be granted followed by 2 non-posted requests from MC and 1 posted request from MA. Since the MA can only receive 1 grant for this arbitration cycle, therefore only 1 of 3 posted requests from MA is able to complete. Once TA is ready to return a read completion for posted requests from MB and MC, completion data is pushed into the shared data buffer queue of agent A behind the 2 pending posted write data from MA. The system arbitration cycle cannot be completed because MB still has an available grant count and outstanding requests that have yet to be serviced (pending for completion data which got blocked behind MA posted write data in agent A).

Embodiments may thus resolve the deadlock by allowing posted requests from MA master with no grant count available to be granted when system arbitration cannot commit another grant for any other master with a grant count remaining. By opportunistically granting the request from the master with no grant count remaining, MA, posted write data from the shared buffer can now be unloaded, thus unblocking completion data going back to MB and MC. MB can start sending its posted request to TA once receiving completion data from TA target. Thus embodiments allow posted requests from MA master to occur via the opportunistic arbitration.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a first arbiter to grant requests from a plurality of requesters according to a fixed priority protocol in which each of the plurality of requesters is granted a predetermined number of fixed grants per arbitration cycle; and
a second arbiter coupled to the first arbiter to grant an opportunistic grant to one of the plurality of requestors in a slot of the arbitration cycle according to an opportunistic grant mechanism if the first arbiter cannot grant a fixed grant to one of the plurality of requestors having a valid number of fixed grants at a time of the slot of the arbitration cycle.

2. The apparatus of claim 1, wherein the first arbiter cannot grant the fixed request due to an unavailable target resource for a request by the one of the plurality of requesters.

3. The apparatus of claim 2, wherein the opportunistic grant is to be provided to one of the plurality of requesters having a fixed grant count equal to zero.

4. The apparatus of claim 1, wherein the second arbiter includes:
an opportunistic grant qualification stage to receive the requests from the plurality of requestors and an output of a grant count qualification stage of the first arbiter;
arbiter logic coupled to an output of the opportunistic grant qualification stage to generate an opportunistic grant signal based on the output of the opportunistic grant qualification stage; and
a selector to receive the opportunistic grant signal and to generate the opportunistic grant based on the opportunistic grant signal and an output of the first arbiter.

5. The apparatus of claim 4, wherein the output of the first arbiter is coupled to the selector of the second arbiter to provide grant information of the first arbiter.

6. The apparatus of claim 4, wherein the arbiter logic comprises a round robin arbiter.

7. The apparatus of claim 1, wherein the opportunistic grant is to resolve an in-out dependency deadlock of a first requestor, wherein the first requester corresponds to a master and a target of the request.

8. A method comprising:
receiving requests from a plurality of requesters in an arbiter that is to provide access to a plurality of target resources;
detecting that a first target resource to be accessed by a first requestor of the plurality of requestors having a valid grant count is unavailable during a slot of an arbitration round associated with the first requestor; and
opportunistically granting an access grant to a second requester of the plurality of requesters to access a second target resource for the slot of the arbitration round, wherein the second requester does not have a valid grant count.

9. The method of claim 8, further comprising granting at least one access grant to the first requestor to access the first target resource when the first target resource becomes available.

10. The method of claim 9, further comprising reloading grant counters for each of the plurality of requestors after granting the at least one access grant to the first requestor.

11. The method of claim 10, further comprising beginning a second arbitration round after reloading the grant counters.

12. The method of claim 8, further comprising implementing the arbitration round having a variable length.

13. The method of claim 12, wherein the variable length corresponds to a fixed number of slots and a variable number of slots that is dependent upon availability of the first target resource.
